(19) United States
(12) Patent Application Publication
(10) Pub. No.: US 2007/0190969 A1
(43) Pub. Date: Aug. 16, 2007

(54) Communication module for facilitating monitoring an existing alarm system via a cellular telephone network

(76) Inventor: Reginald Gray, Rex, GA (US)

Correspondence Address: RICHARD L. MILLER, 12 PARKSIDE DRIVE, DIX HILLS, NY, 11746, US

(21) Appl. No.: 11/355,527

(22) Filed: Feb. 16, 2006

(51) Int. Cl. H04M 11/04

(52) U.S. Cl. 455/404.1

(57) ABSTRACT

A communication module for facilitating monitoring an existing alarm system via a cellular telephone network. A microphone receives a specific sound from the existing alarm system, and in response thereto, generates electrical signals. A programmable alarm sound recognition circuitry is in electrical communication with the microphone and recognizes the electrical signals generated by the microphone, and in response thereto, sends a wireless signal to the cellular telephone network alerting a user of the telephone that the existing alarm system has activated. Programmable phone number circuitry is in electrical communication with the programmable alarm sound recognition circuitry and dials the telephone when the programmable alarm sound recognition circuitry is activated.

### BACKGROUND OF THE INVENTION

1. Field of the Invention

The present invention relates to a module for interfacing with a cellular telephone, and more particularly, the present invention relates to a communication module for facilitating monitoring an existing alarm system via a cellular telephone network.

2. Description of the Prior Art

Numerous innovations for alarm interfaced systems have been provided in the prior art that will be described. Even though these innovations may be suitable for the specific individual purposes to which they address, however, they differ from the present invention.

A FIRST EXAMPLE, U.S. Pat. No. 5,081,667 issued on Jan. 14, 1992 to Drori et al. teaches an interfacing system for integrating a wide variety of cellular communication systems with most vehicle security systems. The system includes a controller and an interfacing arrangement for matching the cellular telephone to the controller. The interfacing arrangement includes a library stored in memory and having a plurality of unique translation tables corresponding to the protocols of a plurality of unique cellular communication systems. The interfacing arrangement further includes an initializing capability for selecting an operating protocol for the interfacing system from the library that is compatible with the protocol of the cellular communication system. Hardware and software are included for interfacing the vehicle security to the controller and for interfacing the controller to the vehicle. In a specific embodiment, the selection of cellular telephone type or make is made from the keypad of the cellular telephone.

A SECOND EXAMPLE, U.S. Pat. No. 5,278,539 issued on Jan. 11, 1994 to Lauterbach et al. teaches an emergency alerting system for alerting or warning large numbers of people of the occurrence or threat of an emergency using available communications media. Multiple facilities are monitored for the occurrence of multiple alarm conditions. On the occurrence of this condition, radio or telephone contact is made with a Local Emergency Planning Committee (LEPC) and the LEPC is notified of the site and nature of the alarm condition. Using a predetermined listing or data bank, the LEPC selects a number corresponding to the site and condition and transmits the number to an automated controller for a radio transmitter. The transmitter may be part of an existing radio paging system. The automated controller—on the basis of the number dialed in by the LEPC—transmits an appropriate Code Assignment Plan (Cap Code) signal. The Cap Code signal is the electronic signature of a preprogrammed Cap Code chip within individual radio receivers positioned at the sites of intended alarm recipients. The Cap Codes are assigned and utilized to effect the notification of predetermined groups related to specific alarm conditions. Upon a receiver being actuated by receipt of its Cap Code, an alarm is actuated to produce a sensory alarm signal such as sound or light. A detector is provided at the alarm site and upon detecting the sensory alarm acknowledges to the monitored facility the occurrence of the alarm.

A THIRD EXAMPLE, U.S. Pat. No. 5,319,698 issued on Jun. 07, 1994 to Glidewell et al. teaches a security system for detecting and signaling the presence of abnormal security or hazardous conditions—such as unauthorized entry, glass breakage, fire, smoke, or high water level—in individual units—such as a boat, a recreational vehicle, or an automobile—that is located or stored in a given security area. The security system includes sensor units that when actuated transmit coded signals through the atmosphere that identifies each sensor unit and the individual unit on which it is located. A receiver on the individual unit recognizes only the coded signals from sensor units that are on the same individual unit as the receiver. A coded output signal is provided to a slave transmitter on the individual unit that identifies the particular sensor unit that was actuated. The slave transmitter provides a coded transmission signal to a local security station that identifies the particular sensor unit that was actuated and the individual unit where the actuated sensor unit resides. The local security station activates an alarm and dials a sequence of telephone numbers to provide a verbal alarm.

A FOURTH EXAMPLE, U.S. Pat. No. 5,587,701 issued on Dec. 24, 1996 to Hess teaches a portable alarm system in which the alarm functions are contained within a portable enclosure, communication is maintained between the enclosure and wireless security contacts placed at points of entry, and the alarm is capable of initiating a telephone call to a security monitor station, either by conventional hard wired telephone lines within a building, by cellular transmission, or via 800 MHz trunking.

A FIFTH EXAMPLE, U.S. Pat. No. 5,777,551 issued on Jul. 07, 1998 to Hess teaches a portable alarm system in which the alarm functions are contained within a portable enclosure, communication is maintained between the alarm system and wireless security contacts placed at points of entry, and the alarm is capable of initiating a telephone call to a security monitor state, either by conventional hard-wired telephone lines within a building or by cellular transmission.

A SIXTH EXAMPLE, U.S. Pat. No. 6,661,340 B1 issued on Dec. 09, 2003 to Saylor et al. teaches a personal security network where an individual's system or systems of security devices may be connected to a central security network. The central security network may monitor a system's status and alert the individual when an alert situation occurs. Provided is a security network where a user may set up personalized alarms and alert services, identify various methods of contact, order at which to be contacted, individuals and entities to be contacted, type of situations to be alerted of and other relevant security, and other information. A personalized web interface is provided where authorized individuals may view current and historical security device status. A user may generate personalized reports based on aggregated historical data based on various user-defined factors. The reports may be displayed to the user in various formats—such as maps, graphs, statistics, and others.

A SEVENTH EXAMPLE, U.S. Pat. No. 6,667,688 B1 issued on Dec. 23, 2003 to Menard et al. teaches an apparatus and process in conjunction with long-range wireless communication networks—such as paging, cell phone, and other networks. The system provides for alarm and other signals received from a security or other type of detection system to be verified by a remote user so as to assist in the cancellation of alarms, so that false dispatches can be prevented.

It is apparent that numerous innovations for alarm interfaced systems have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

Accordingly, it is an object of the present invention to provide a communication module for facilitating monitoring an existing alarm system via a cellular telephone network that avoids the disadvantages of the prior art.

Briefly stated, another object of the present invention is to provide a communication module for facilitating monitoring an existing alarm system via a cellular telephone network. A microphone receives a specific sound from the existing alarm system, and in response thereto, generates electrical signals. A programmable alarm sound recognition circuitry is in electrical communication with the microphone and recognizes the electrical signals generated by the microphone, and in response thereto, sends a wireless signal to the cellular telephone network alerting a user of the telephone that the existing alarm system has activated. Programmable phone number circuitry is in electrical communication with the programmable alarm sound recognition circuitry and dials the cellular telephone when the programmable alarm sound recognition circuitry is activated.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

FIG. 1 is a block diagram of the communication module of the present invention facilitating monitoring an existing alarm system via a cellular telephone network; and

FIG. 2 is a block diagram showing further details of the communication module of the present invention shown in FIG. 1.

### LIST OF REFERENCE NUMERALS UTILIZED IN THE DRAWING

10 communication module of present invention for facilitating monitoring existing alarm system 12 via cellular telephone 14
12 existing alarm system
14 cellular telephone
15 keypad of cellular telephone 14
16 microphone for receiving specific sound 20 from existing alarm system 12, and in response thereto, generates electrical signals 21
18 programmable alarm sound recognition circuitry is for sending wireless signal 22 to cellular telephone 14 is response to recognizing electrical signals 21 generated by microphone 16 alerting user of cellular telephone 14 that existing alarm system 12 has activated
20 specific sound from existing alarm system 12
21 electrical signals generated by microphone 16 in response to receipt of specific sound 20 from existing alarm system 12
22 bidirectional signals for communicating with cell towers 34 and wireless signals sent by programmable alarm sound recognition circuitry 18 in response to recognition of electrical signals 21 generated by microphone 16
24 programmable phone number circuitry for dialing cellular telephone 14 when programmable alarm sound recognition circuitry 18 is activated
26 programmable voice message circuitry for interfacing with cellular telephone 14 to generate multiple voice messages when programmable phone number circuitry 24 has connected with cellular telephone 14
28 cell phone circuitry of communication module 10
30 key pad of the communication module 10 for programming required data
32 display screen associated with keypad 30 of communication module 10
34 cell towers of a cellar telephone network
36 antenna for communicating with cell towers

### DETAILED DESCRIPTION OF THE PREFERRED EMBODIMENT

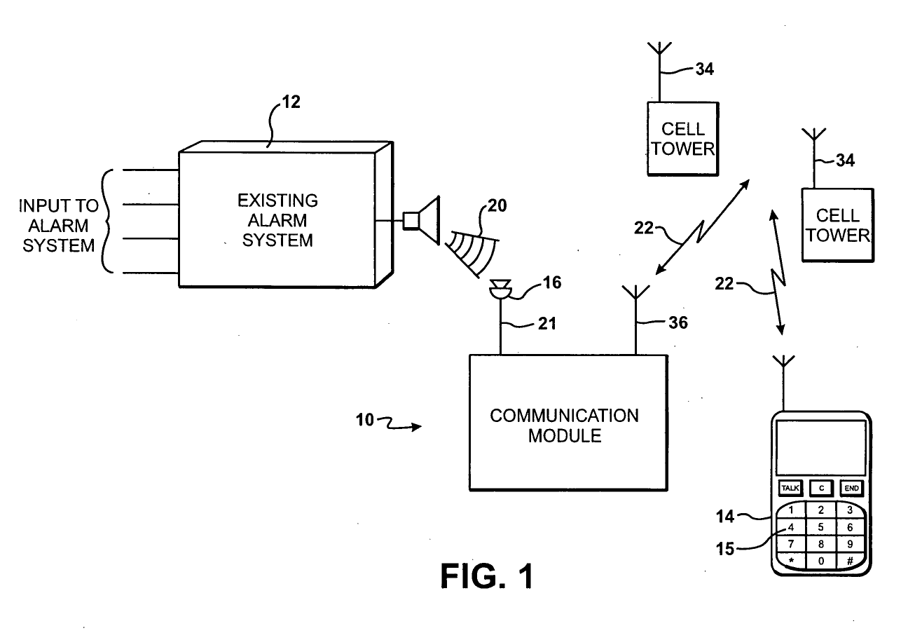

Referring now to the figures, in which like numerals indicate like parts, and particularly to FIG. 1, which is a block diagram of the communication module of the present invention facilitating monitoring an existing alarm system via a cellular telephone network, in which the communication module of the present invention is shown generally at 10 for facilitating monitoring an existing alarm system 12 via a cellular telephone network 34 and telephone 14 having a keypad 15.

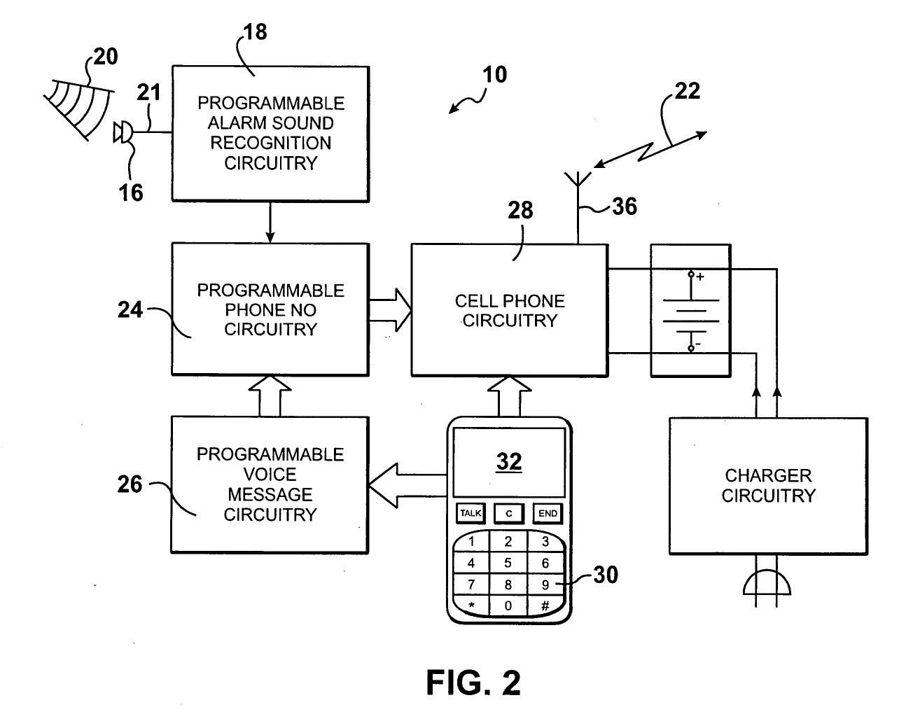

The configuration of the communication module 10 can best be seen in FIG. 2, which is a block diagram of the communication module of the present invention shown in FIG. 1, and as such, will be discussed with reference thereto.

The communication module 10 comprises a microphone 16 and programmable alarm sound recognition circuitry 18.

The microphone 16 is for receiving a specific sound 20 from the existing alarm system 12, and in response thereto, generates electrical signals 21.

The programmable alarm sound recognition circuitry 18 is in electrical communication with the microphone 16 and recognizes the electrical signals 21 generated by the microphone 16, and in response thereto, communicates by a wireless signal 22, via antenna 36 which arrives at the cellular telephone 34 alerting a user of the telephone 14 that the existing alarm system 12 has activated.

The communication module 10 further comprises programmable phone number circuitry 24.

The communication module 10 further comprises cell phone circuitry 28 for communicating, via bidirectional signal 22 and antenna 36, with cell towers 34 of a cellular telephone network and a keypad 30 with an associated display screen 32 so as to facilitate the programming of input data required during the installation and maintenance of the communication module 10.

The programmable phone number circuitry 24 is in electrical communication with the programmable alarm sound recognition circuitry 18 and is for dialing the cellular telephone network 34 when the programmable alarm sound recognition circuitry 18 is activated.

The programmable phone number circuitry 24 can be programmed to also dial two other numbers, such as a work number or an alternate number, such as a neighbor, a trusted friend, or 911.

The programmable phone number circuitry 24 can dial any combination of the three programmed numbers.

The communication module 10 further comprises programmable voice message circuitry 26.

The programmable voice message circuitry 26 is for interfacing with the cellular telephone circuitry 28 to generate multiple voice messages, such as “your home alarm is now activated,” when the programmable phone number circuitry 24 has connected with the telephone 14.

The voice message can also ask “do you want to reset your alarm?” If the answer is “yes,” the user uses a predetermined key of the keypad 15 of the telephone 14 to reset the existing alarm system 12, for example, the “*” key or alternatively key pad 30 of the communication module 10. When the system is up and running correctly it should be further noted that the user may in general enter data via either key pad 15 of a connected telephone or key pad 30 built into the communication module 10 and accordingly the following text will not mention both in every example.

The voice message can also ask “do you want to dial 911?” If the answer is “yes,” the user uses a predetermined key of the keypad 15 of the telephone 14 to dial 911, for example, the “1” key.

The voice message can also ask “do you want to turn your alarm off?” If the answer is “yes,” the user uses a predetermined key of the keypad 15 of the telephone 14 to turn off the existing alarm system 12.

It will be understood that each of the elements described above, or two or more together, may also find a useful application in other types of constructions differing from the types described above.

While the invention has been illustrated and described as embodied in a communication module for facilitating monitoring an existing alarm system via a cellular telephone, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A communication module for facilitating monitoring an existing alarm system via a cellular telephone network having a keypad, comprising:
a) a microphone;
b) programmable alarm sound recognition circuitry and;
c) cell phone circuitry;
wherein said microphone is for receiving a specific sound from the existing alarm system, and in response thereto, generates electrical signals;
wherein said programmable alarm sound recognition circuitry is in electrical communication with said microphone; and
wherein said programmable alarm sound recognition circuitry recognizes said electrical signals generated by said microphone, and in response thereto, sends a wireless signal to the cellular telephone network alerting a user of a telephone that the existing alarm system has activated.

2. The module of claim 1, further comprising programmable phone number circuitry.

3. The module of claim 2, wherein said programmable phone number circuitry is in electrical communication with said programmable alarm sound recognition circuitry.

4. The module of claim 2, wherein said programmable phone number circuitry is for dialing the cellular telephone network when said programmable alarm sound recognition circuitry is activated.

5. The module of claim 2, wherein said programmable phone number circuitry is programmable to dial multiple numbers.

6. The module of claim 5, wherein one number is a work number of the user.

7. The module of claim 5, wherein one number is a neighbor's number of the user.

8. The module of claim 5, wherein one number is a trusted friend's number of the user.

9. The module of claim 5, wherein one number is 911.

10. The module of claim 5, wherein said programmable phone number circuitry dials any combination of the multiple numbers.

11. The module of claim 2, further comprising programmable voice message circuitry.

12. The module of claim 11, wherein said programmable voice message circuitry is for interfacing with the cell phone circuitry to generate multiple voice messages when said programmable phone number circuitry has connected with the telephone.

13. The module of claim 12, wherein one voice message is “do you want to reset your alarm?”

14. The module of claim 13, wherein a predetermined key of the keypad of the telephone is used by the user to reset the existing alarm system.

15. The module of claim 12, wherein one voice message is “do you want to dial 911?”

16. The module of claim 15, wherein a predetermined key of the keypad of the telephone is used by the user to dial 911.

17. The module of claim 12, wherein one voice message is “do you want to turn your alarm off?”

18. The module of claim 17, wherein a predetermined key of the keypad of the telephone is used by the user to turn off the existing alarm system.

19. The module of claim 15, wherein a predetermined key of the keypad for programming the communication module is used by the user to dial 911.

20. The module of claim 17, wherein a predetermined key of the keypad for programming the communication module is used by the user to turn off the existing alarm system.
